(19) United States
(12) Patent Application Publication
(10) Pub. No.: US 2012/0118895 A1
(43) Pub. Date: May 17, 2012

(54) Bag tuck for trash receptacle

(76) Inventor: Ching-Chang Lin, San Chung City (TW)

(21) Appl. No.: 12/927,480

(22) Filed: Nov. 16, 2010

(51) Int. Cl. B65D 25/14; B23P 19/04

(52) U.S. Cl. 220/495.11; 29/700

(57) ABSTRACT

A trash receptacle system includes an outer shell and an inner liner. The inner liner includes a cut-out and a gate having a hinged attachment proximate the cut-cut. The gate is movable about the hinged attachment between an open configuration where the cut-out is exposed and a closed configuration where the gate extends across the cut-out to secure a trash to the inner liner.

### BACKGROUND

The present disclosure relates generally to trash receptacle systems and more specifically to a method and device for securing a trash bag to a trash can.

Most modern locations have one or more trash receptacles for temporarily storing waste. Once an item becomes “trash”, it is usually tossed into a local trash receptacle or “can”. A trash can is often lined with a trash bag and equipped with a lid to manage any mess and/or odor that may emanate from the aging trash. Once the trash bag is full or the odor becomes potent, the trash bag is removed from the trash can, transported to a more remote location, and replaced with a new trash bag.

### SUMMARY

A first embodiment in accordance with the present disclosure is a trash receptacle system including an outer shell and an inner liner. The outer shell has a sealed lower portion and an upper portion with a removable lid. The inner liner is removably retained within the outer shell and includes a closed bottom, an open top, at least one side wall, a cut-out, and a gate. The closed bottom is positioned above the sealed lower portion of the outer shell, the open top is positioned proximate the upper portion of the outer shell with the removable lid, and the at least one side wall extends upwardly from the closed bottom to the open top. The cut-out is located on the at least one side wall proximate the open top. The gate has a hinged attachment to the at least one side wall proximate the cut-out, and is movable about the hinged attachment between an open configuration where the cut-out is exposed and a closed configuration where the gate extends across the cut-out.

A second embodiment in accordance with the present disclosure is an inner liner for a trash receptacle system including a closed bottom, an open top, a forward wall, a rearward wall, a first side wall, and a second side wall. Each wall extends upwardly from the closed bottom to the open top to form a four-sided open top receptacle. A first cut-out is located on the first side wall proximate the open top and a second cut-out is located on the second side wall proximate the open top. A first gate has a first hinged attachment to the first side wall proximate the first cut-out, and a second gate has a second hinged attachment to the second side wall proximate the second cut-out. The first and second gates are each movable about their respective hinged attachments in order to secure a trash bag to the inner liner.

A third embodiment in accordance with the present disclosure is a method for securing a trash bag to an inner liner of a trash receptacle system. The method includes placing the trash bag into the inner liner of the trash receptacle system and opening a first gate about a first hinged attachment to a first wall of the inner liner of the trash receptacle system thereby exposing a first cut-out located in the first wall. The method further includes positioning a first portion of the trash bag across the first cut-out and closing the first gate about the first hinged attachment thereby trapping the first portion of the trash bag between the first cut-out and the first gate and securing the trash bag within the inner liner.

### BRIEF DESCRIPTION OF THE DRAWINGS

FIG. 1 is a perspective view of a trash bag secured to an inner liner of a trash receptacle system in accordance with the present disclosure.

FIG. 2 is a perspective view of the inner liner from FIG. 1 with the trash bag removed.

FIG. 3 is a side view of inner liner from FIG. 2.

FIG. 4 is a cross section of the inner liner from FIG. 3.

FIG. 5 is a top view of the inner liner from FIG. 4.

FIGS. 6-8 are a series of perspective views showing how a gate secures the trash bag to the inner liner.

FIG. 9 is a perspective view of the inner liner received into an outer shell to form the trash receptacle system.

### DETAILED DESCRIPTION

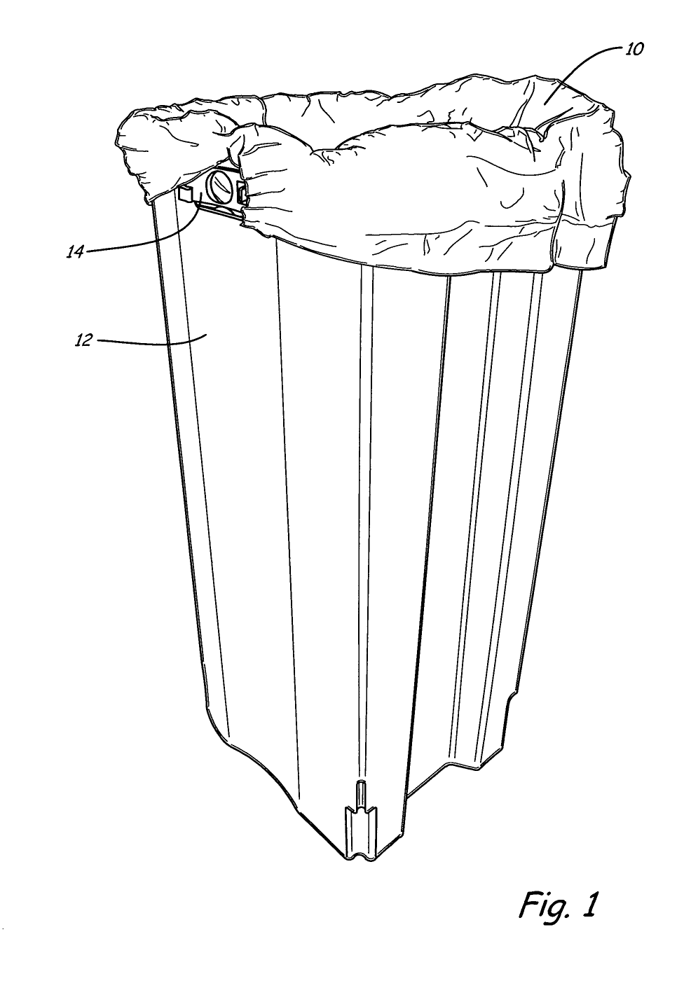

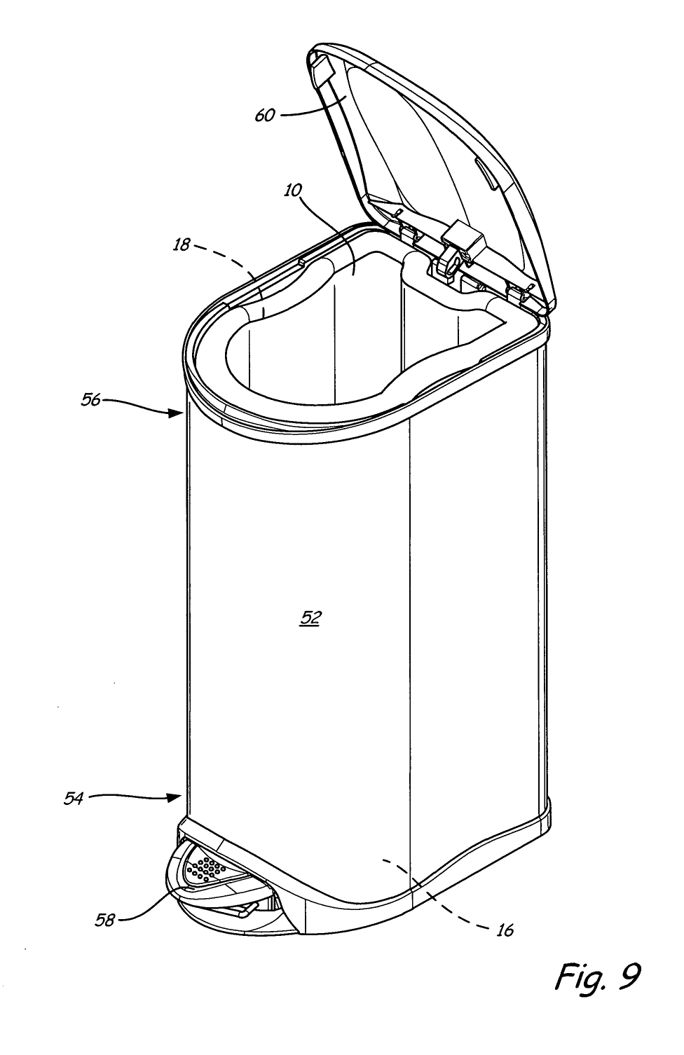

FIG. 1 is a perspective view of trash bag 10 secured to inner liner 12 of a trash receptacle system in accordance with the present disclosure. Trash bag 10 is held open and secured around a top lip of inner liner 12 by gate 14. Inner liner 12 can be received into an outer shell or “trash can” having a foot pedal operated lid to form the trash receptacle system (shown in FIG. 9). Any excess portion of trash bag 10 opening can be fed through gate 14 and pulled tight against the lip of inner liner 12 so that trash bag 10 is fully contained within the outer shell. Once secured, placing a heavy item into trash bag 10 will not cause trash bag 10 to fall downwardly into inner liner 12. Use of gate 14 reduces messes caused by trash bag 10 slipping into inner liner 12 and improves the overall visual appearance of the trash receptacle system.

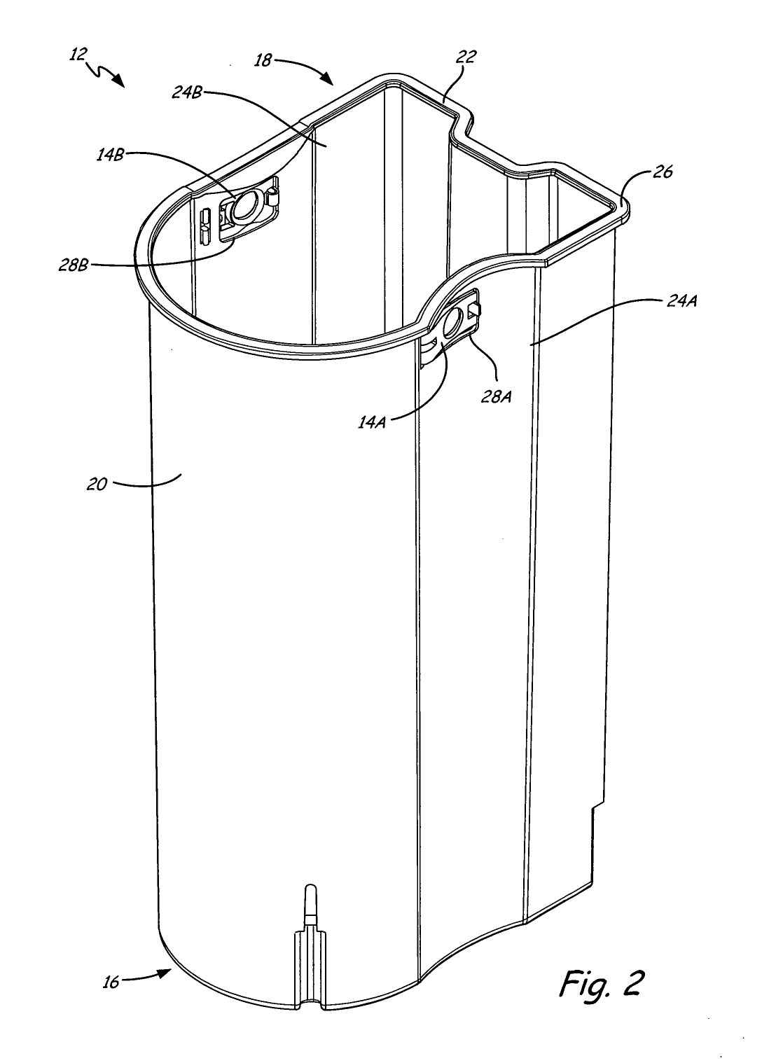

FIG. 2 is a perspective view of inner liner 12 from FIG. 1 with trash bag 10 removed. Inner liner 12 includes two gates: first gate 14A and second gate 14B. Inner liner 12 is an upright container formed by bottom 16, top 18, front or forward wall 20, back or rearward wall 22, first side wall 24A, and second side wall 24B. Top 18 includes lip 26, first side wall 24A includes first cut-out 28A, and second side wall 24B includes second cut-out 28B. Gates 14A, 14B are attached to side walls 24A, 24B, respectively, to secure trash bag 10 taught around lip 26.

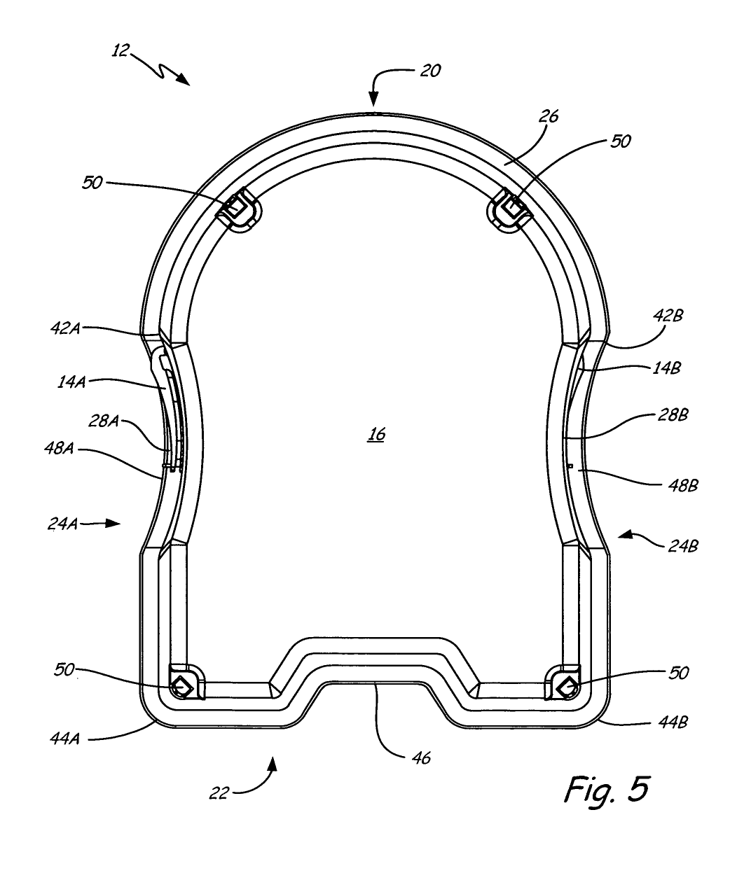

In the depicted embodiment, inner liner 12 is formed from plastic, although other materials are equally possible. Inner liner 12 has flat, horizontally extending, closed bottom 16 for resting on a surface such as a floor. Spaced vertically above bottom 16, is horizontally extending, open top 18. Bottom 16 and top 18 share the same shape (described with respect to FIG. 5) and lie in the same vertical plane. Extending vertically to connect bottom 16 to top 18 are front wall 20, back wall 22, first side wall 24A, and second side wall 24B. Each of front wall 20, back wall 22, first side wall 24A, and second side wall 24B are about 57.5 centimeters (hereinafter “cm”) tall such that top 18 is spaced vertically about 57.5 cm above bottom 16. Front wall 20 is opposite back wall 22, and first side wall 24A is opposite second side wall 24B. Front wall 20 is semicircular in shape and extends in a convex curve between first side wall 24A and second side wall 24B. Back wall 22 extends between first side wall 24A and second side wall 24B. Together, front wall 20, back wall 22, first side wall 24A, and second side wall 24B form the upright container structure of inner liner 12 for receiving trash bag 10.

Extending continuously around top 18 of inner liner 12 is lip 26. Lip forms a small horizontal protrusion at a top edge of each of front wall 20, back wall 22, first side wall 24A, and second side wall 24B. A bottom of trash bag 10 can be received into inner liner 12 and placed above bottom 16. A top of trash bag 10 can be opened about top 18. The top edges of trash bag 10 can be pulled outwardly across lip 26 such that the trash bag is held open around entire top 18 of inner liner 12. Trash bag 10 can also be pulled slightly downwardly parallel to each sidewall 24A, 24B. In other words, trash bag 10 is folded over and covering lip 26 (as shown in FIG. 1). Located on each sidewall 24A, 24B, just beneath top 18 and lip 26 are mechanisms for securing trash bag to inner liner 12. First cut-out 28A and first gate 14A are located at the top forward corner of first side wall 24A adjacent both front wall 20 and lip 26. Similarly, second cut-out 28B and second gate 14B are located at the top forward corner of second side wall 24B adjacent both front wall 20 and lip 26. First cut-out 28A and second cut-out 28B are identical and the discussion below of first cut-out 28A also applies to second cut-out 28B. Similarly, first gate 14A and second gate 14B are identical and the discussion below of first gate 14A also applies to second gate 14B.

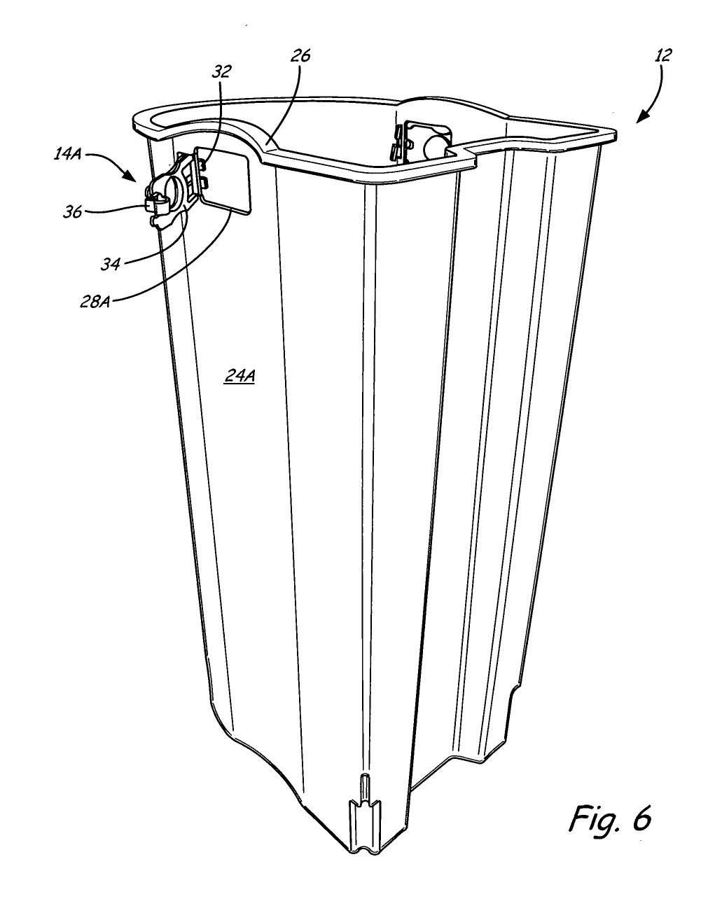

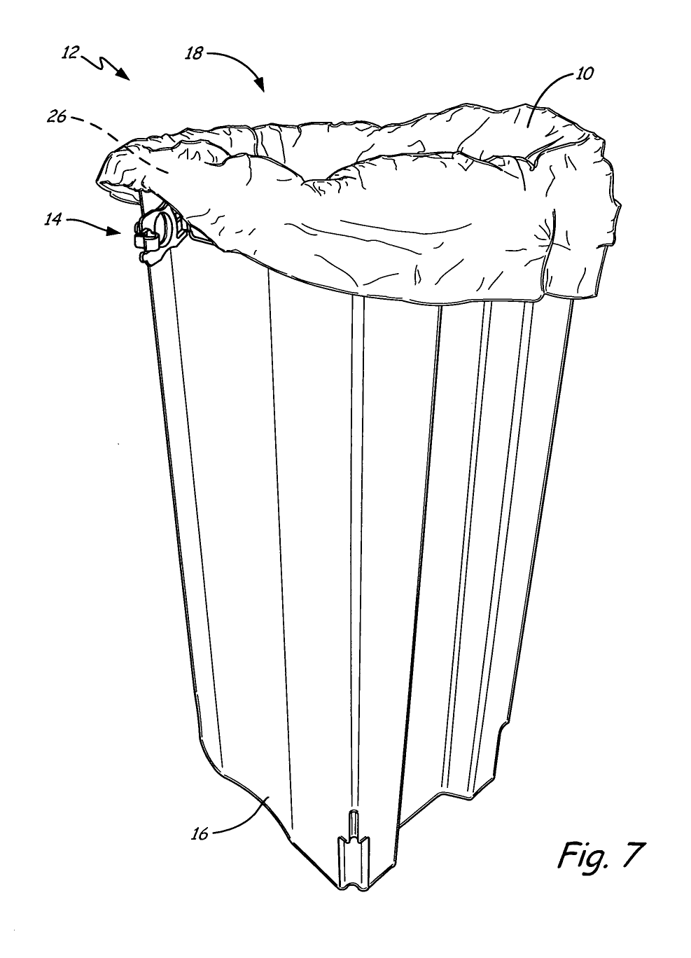

First cut-out 28A is a substantially rectangular void in first side wall 24A. The longer sides of first cut-out 28A extend horizontally (parallel bottom 16 and top 18) and the shorter sides of first cut-out 28A extend vertically (parallel first side wall 24A). The corners of first cut-out 28A (where the long sides meet the short sides) are rounded. First gate 14A assumes an overall shape similar to that of first cut-out 28A, but slightly smaller. First gate 14A is attached by a hinge to first side wall 24A near the shorter front side of first cut-out 28A. First gate 14A moves about the hinge between a closed position and an open position. When in the closed position (depicted in FIG. 2) first gate 14A extends across and lays within first cut-out 28A. So positioned, gate 14A substantially covers the entire void of first cut-out 28A and completes the structure of first side wall 24A. When in an open position (depicted in FIGS. 6-7) the void of first cut-out 28A is exposed such that a hole appears in the structure of first side wall 24A. The upper edges of trash bag 10 can be pulled from the outside of inner liner 12, through first cut-out 28A, to the inside of inner liner 12. First gate 14A is then closed to trap trash bag 10 between first cut-out 28A and first gate 14A, thereby securing trash bag 10 to first side wall 24A inner liner 12.

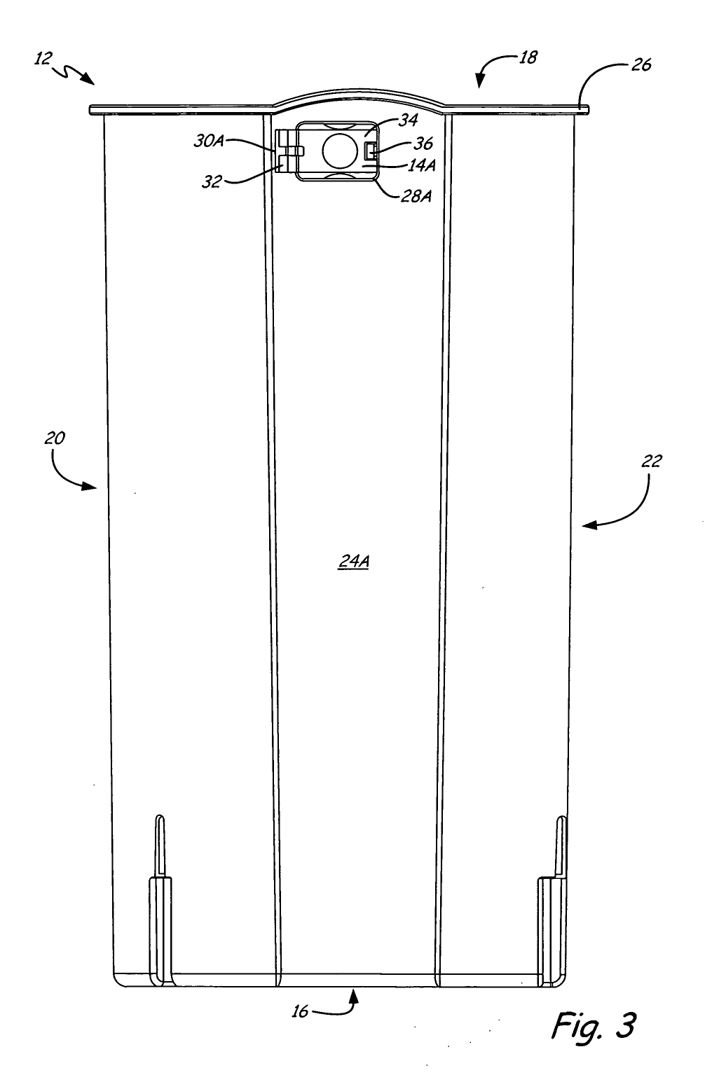

FIG. 3 is side view of inner liner 12 from FIG. 2 showing an outside view of first side wall 24A. Depicted in FIG. 3 are first gate 14A, bottom 16, top 18, front wall 20, back wall 22, first side wall 24A, lip 26, first cut-out 28A, and first hinge hole 30A. Also shown are components of first gate 14A: hinge 32, body 34, and spring clip 36. Since the components of second gate 14B are identical to the components of first gate 14A, the discussion below applies equally to both first gate 14A and second gate 14B.

As discussed above, front wall 20, back wall 22, first side wall 24A, and second side wall 24B (not visible) extend upwardly from bottom 16 to top 18 to form a inner liner 12 for collecting trash. Located just below lip 26 near where front wall 20 joins first side wall 24A is first cut-out 28A. First cut-out 28A is a portion of first side wall 24A that has been removed to create a hole or void. Located between first cut-out 28A and front wall 20 is first hinge hole 30A. First hinge hole 30A is therefore, located closer to front wall 20A than first cut-out 28A. (Note second hinge hole 30B is identically situated on second side wall 24B and therefore, the present discussion applies equally to both first hinge hole 30A and second hinge hole 30B.) Like first cut-out 28A, first hinge hole 30A is a substantially rectangular void in first wall 24A and has rounded corners. First hinge hole 30A, however, is substantially smaller and oriented opposite the direction of first cut-out 28A. In other words, the short sides of first hinge hole 30A are parallel with top bottom 16 and top 18 while the long sides are parallel with first side wall 24A. The short side of first hinge hole 30A located closest to top 18 is substantially in line with the top long side of first cut-out 28A. Similarly, the short side of first hinge hole 30A located closest to bottom 16 is substantially in line with bottom long side of first cut-out 28A. In other words, first cut-out 28A and first hinge hole 30A are located side by side and separated only by a small piece of first side wall 24A.

First gate 14A (as well as second gate 14B) includes hinge 32, body 34, and spring clip 36. Hinge 32 is attached to a front short side of first gate 14A and spring clip 36 is attached to a back short side of first gate 14A. Extending between hinge 32 and spring clip 36 is body 34. Hinge 32 has a top protrusion and a bottom protrusion, both of which extend into first hinge hole 30A and form a pivot point for first gate 14A. When first gate 14A is in the closed position, body 34 extends rearwardly from hinge 32 to lie within and cover the void created by first cut-out 28A. Spring clip 36 can secure first gate 14A in this closed position by engaging the back short side of first cut-out 28. When not secured, spring clip 36 and body 34 can move horizontally about a vertical axis formed through hinge 32, outwardly and away from first side wall 24A. In a fully open position, body 34 extends forwardly from hinge 32 placing spring clip 36 closer to front wall 20 and exposing the void of first cut-out 28A. In use, first gate 14A is pivoted open about hinge 32 to receive trash bag 10 through first cut-out 28A. First gate 14A is then pivoted closed and secured by spring clip 36 such that trash bag 10 is trapped between first-cut 28A and body 34.

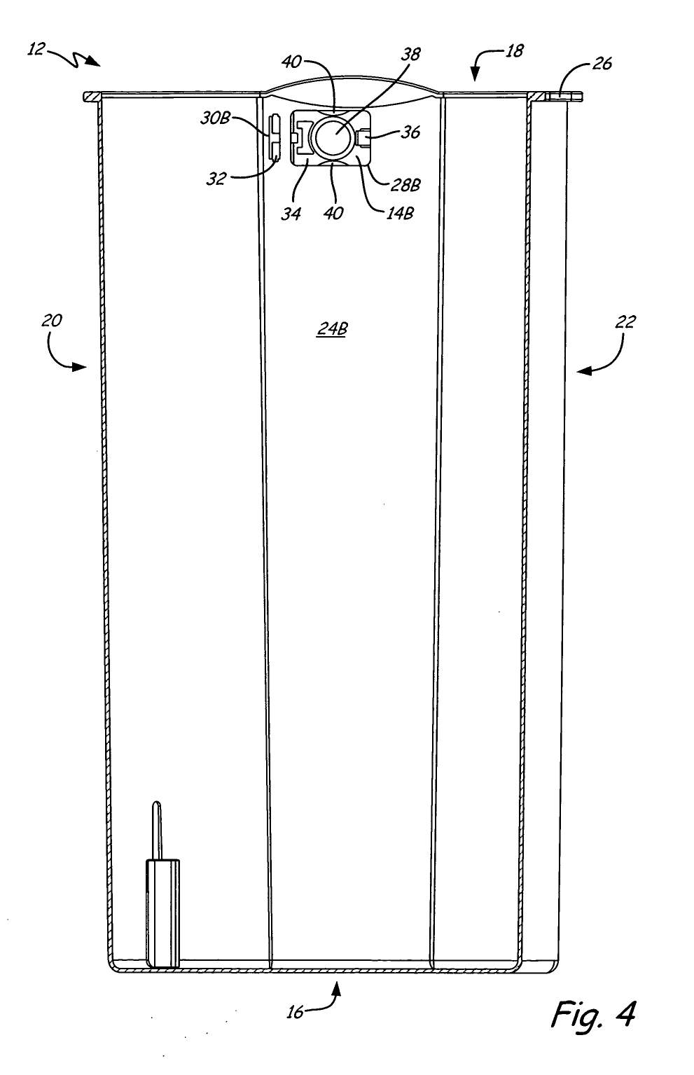

FIG. 4 is a cross section of inner liner 12 from FIG. 3 showing an inside view of second side wall 24B. Depicted in FIG. 4 are second gate 14B, bottom 16, top 18, front side 20, back side 22, second side wall 24B, second cut-out 28B, and second hinge hole 30B. Also shown are components of second gate 14B: hinge 32, body 34, spring clip 36, aperture 38, and indentations 40. Since the components of second gate 14B are identical to the components of first gate 14A, the discussion below applies equally to both first gate 14A and second gate 14B.

Lip 26 extends upwardly as it passes along second side wall 24B to form a raised portion of lip 26. This raised portion of lip 26 also occurs along first side wall 24A so that there are two raised portions of lip 26 equidistance from one another at top 18 of inner liner 12. The raised portions of lip 26 offers a convenient means for grasping either side of inner liner 12 and resemble handles.

Second hinge hole 30B is located between front wall 20 and second side wall 24B. Second gate 14B includes hinge 32 having a top and a bottom protrusion. The protrusions of hinge 32 extend through second hinge hole 30B from the outside of inner liner 12 to the inside of inner liner 12. Attached to hinge 32 is body 34, and attached to body 34 is spring clip 36. When second gate 14B is closed, body 34 and spring clip 36 extend rearwardly across second cut-out 28B. When second gate 14B is open, body and spring clip 36 extend outwardwardly to expose second cut-out 28B. If body 34 and spring clip 36 are pivoted fully about hinge 32, body 34 and spring clip 36 extend forwardly. Located centrally within body 34 is aperture 38. Aperture 38 is a void or hole in body 34 which aids in securing trash bag 10 into second cut-out 28B. Located above and below aperture 38 are arcuate or semi-circular indentations 40. One indentation 40 extends downwardly from the top long side of second gate 14B into body 34 and toward aperture 38. Another indentation 40 extends upwardly from the bottom long side of second gate 14B into body 34 and toward aperture 38. Aperture 38 and indentations 40 have similar diameters and are aligned in a vertical column along center of body 34. Indentations 40 form a place on the top and the bottom of body 34 to grasp and impart hinging movement to second gate 14B.

FIG. 5 is a top view of inner liner 12 from FIG. 3. Depicted in FIG. 5 are first gate 14A, second gate 14B, bottom 16, front wall 20, back wall 22, first side wall 24A, second side wall 24B, lip 26, first cut-out 28A, second cut-out 28B, first seam 42A, second seam 42B, first corner 44A, second corner 44B, back indentation 46, first side indentation 48A, second side indentation 48B, and guides 50. First gate 14A cooperates with first cut-out 28A to secure trash bag 10 to first side 24A, and second gate 14B cooperates with second cut-out 28B to secure trash bag 10 to second side 24B of inner liner 12.

When viewed from the top, the overall shape of inner liner 12 resembles a tooth. The shape of inner liner 12 may vary, but the depicted embodiment is adapted to fit within a semi-circular outer shell (shown in FIG. 9). Front wall 20 extends about 35 cm in an arc from first seam 42A with first side wall 24A to second seam 42B with second side wall 24B. Back wall 22 extends about 22 cm from first corner 44A with first side wall 24A to second corner 44B with second side wall 24B. Centrally located within back wall 22 is back indentation 46 having a width of about 8 centimeters. Back indentation 46 may provide room for pedal operated lid mechanics when inner liner 12 is inserted into an outer shell to form a trash receptacle system.

First side wall 24A has first side indentation 48A and second side wall 24B has second side indentation 48B. Each side indentation 48A, 48B has a width of about 11 cm. First side indentation 48A is the most forward portion of first side wall 24A and therefore, first side indentation 48A is attached to front wall 20 at first seam 42. Similarly, second side indentation 48B is the most forward portion of second side wall 24B such that second side indentation 48B is attached to front wall 20 at second seam 42. Side indentations 48A, 48B are arcuate and concave. First gate 14A and first cut-out 28A are located on first side indentation 48A and are curved to exhibit the same arcuate, concave line. Similarly, second gate 14A and second cut-out 28A are located on second side indentation 48B and are curved to exhibit the same arcuate, concave line. The locations of side indentations 48A, 48B coincide with the raised profile of lip 26 (discussed above with reference to FIG. 4) such that side indentations 48A, 48B and raised lip 26 form handles for lifting inner liner 12 out of the outer shell (shown in FIG. 9) of the trash receptacle system. In the depicted embodiment, four guides 50 are spaced along an interior of inner liner 12. A first and a second guide 50 are located on forward wall 20, a third guide 50 is located at first corner 44A, and fourth guide 50 is located at second corner 44B. Guides 50 are recesses formed into lower portions of the walls of inner liner 12. Guides 50 are configured to mate with matching protrusions formed in the lower portion of outer shell. Through this mating design, guides 50 help guide inner liner 12 into proper alignment within the outer shell to form the trash receptacle system.

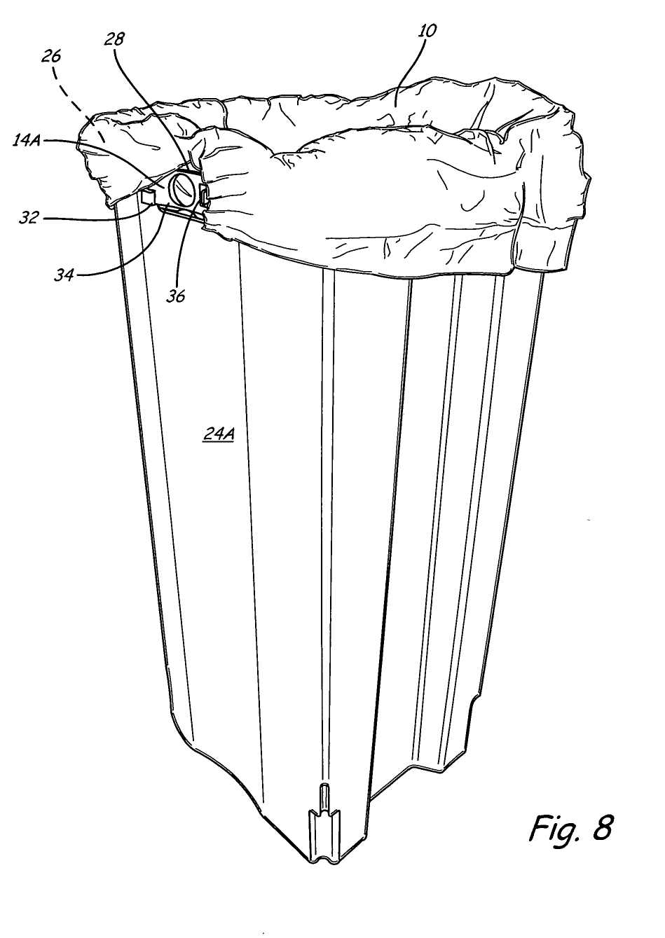

FIGS. 6-8 are a series of perspective views showing how first gate 14A secures trash bag 10 to inner liner 12. FIG. 6 depicts inner liner 12 with first gate 14A in an open position before introduction of trash bag 10. FIG. 7 depicts the introduction of trash bag 10 into inner liner 12 with first gate 14A in the open position. FIG. 8 depicts closure of first gate 14A to secure trash bag 10 to inner liner 12. Familiar features from previous Figures are labeled such as bottom 16, top 18, first side wall 24A, first cut-out 28A, hinge 32, body 34, and spring clip 36.

FIG. 6 shows inner liner 12 before insertion of trash bag 10. In preparation for trash bag 10, spring clip 36 is released from engagement with back side of first cut-out 28A. Spring clip 36 and body 34 are moved horizontally and forward about hinge 32 to expose first cut-out 28A. FIG. 7 shows introduction of trash bag 10 into inner liner 12. The lower closed end of trash bag 10 can be placed within inner liner 12 near bottom 16. The open upper end of trash bag 10 can be pulled upwardly and outwardly at top 18 toward rim 26. At rim 26 the upper end of trash bag can be pulled downwardly such that upper end of trash bag 10 is folding over rim 26 and hanging down in front of first cut-out 28. At this point, the upper end of trash bag 10 is positioned between open first gate 14A and first cut-out 28. FIG. 8 shows first gate 34A in a closed position to secure trash bag 10 to inner liner 12. Spring clip 36 and body 34 have pivoted about hinge 32 such that body 34 traps trash bag 10 in first cut-out 28A. Spring clip 36 engages back side of first cutout 28A either directly or though trash bag 10 to lock first gate 14A in the closed position thereby securing trash bag 10 to inner liner 12. The above discussion of the functionality of first gate 14A applies equally to second gate 14B. First gate 14A and second gate 14B can be used simultaneously or in succession to secure opposite sides of trash bag 10 to first side wall 24A and second side wall 24B of inner liner 12.

FIG. 9 depicts insertion of inner liner 12 (including secured trash bag 10) into outer shell 52 to form the trash receptacle system. Bottom 16 and top 18 of inner liner 12 are shown in phantom. Components of outer shell 52 are labeled and include upper portion 54, lower portion 56, food pedal 58, and lid 60. FIG. 9 shows how inner liner 12 can be received into outer shell 52 after trash bag 10 is secured by first gate 14A and second gate 14B to inner liner 12.

Bottom 16 of inner liner 12 is received into outer shell 52. Guides 50 (shown in FIG. 5) position bottom 16 of inner liner 12 above sealed lower portion 54 of outer shell 52. So received, top 18 of inner liner 12 is positioned proximate upper portion 56 of outer shell 52. Inner liner 12 is slightly shorter than outer shell 56 such that top 18 does not extend above a top edge of upper portion 56. First gate 14A and second gate 14B keep trash bag 10 from extending out over a top edge of upper portion. Foot pedal 58 located on lower end 54 operates lid 60 located on upper end 56. When lid 60 is closed, trash bag 10 cannot seep out between lid 60 and upper portion 56 because trash bag 10 is tightly secured to inner liner 12 by first gate 14A and second gate 14B. Use of gates 14A, 14B reduces messes caused by trash bag 10 slipping into inner liner 12 and improves the overall visual appearance of the trash receptacle system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A trash receptacle system comprising:
an outer shell having a sealed lower portion and an upper portion with a removable lid; and
an inner liner removably retained within the outer shell, the inner liner including:
a closed bottom positioned above the sealed lower portion of the outer shell;
an open top positioned proximate the upper portion of the outer shell with the removable lid;
at least one side wall extending upwardly from the closed bottom to the open top;
a cut-out located on the at least one side wall proximate the open top; and
a gate having a hinged attachment to the at least one side wall proximate the cut-out, the gate being movable about the hinged attachment between an open configuration where the cut-out is exposed and a closed configuration where the gate extends across the cut-out.

2. The trash receptacle system of claim 1, wherein the gate includes a first side and an opposite second side, the first side having the hinged attachment to the at least one side wall and the second side having a spring clip for securing the gate to the at least one side wall in the closed configuration.

3. The trash receptacle system of claim 1, wherein the gate swings horizontally away from the at least one side wall when moving between the closed configuration and the open configuration.

4. The trash receptacle system of claim 1, wherein the gate lies within the cut-out when in the closed configuration.

5. The trash receptacle system of claim 1, wherein both the cut-out and the gate are approximately rectangular.

6. The trash receptacle system of claim 5, wherein the gate includes a central aperture.

7. The trash receptacle system of claim 6, wherein the gate includes a top side and a bottom side, the top side and the bottom side each having an arcuate indentation.

8. The trash receptacle system of claim 7, wherein the gate further includes a first side and a second side, both the first side and second side extending between the top side and the bottom side to complete the approximately rectangular gate, wherein the first side has the hinged attachment to the at least one side wall and the second side has a spring clip for securing the gate to the at least one side wall in the closed configuration.

9. An inner liner for a trash receptacle system, the inner liner comprising:
a closed bottom and an open top;
a forward wall, a rearward wall, a first side wall, and a second side wall, each wall extending upwardly from the closed bottom to the open top to form a four-sided open top receptacle;
a first cut-out located on the first side wall proximate the open top and a second cut-out located on the second side wall proximate the open top;
a first gate having a first hinged attachment to the first side wall proximate the first cut-out, and a second gate having a second hinged attachment to the second side wall proximate the second cut-out, wherein the first and second gates are each movable about their respective hinged attachments in order to secure a trash bag to the inner liner.

10. The inner liner of claim 9, wherein the first side wall includes a first arcuate indentation, and the second side wall includes a second arcuate indentation.

11. The inner liner of claim 10, wherein the first cut-out is positioned within and curved to match the first indentation, and the second cut-out is positioned within and curved to match the second arcuate indentation.

12. The inner liner of claim 11, wherein the rearward wall includes a centrally located indentation, the centrally located indentation being equidistance from the first cut-out and the second cut-out.

13. The inner liner of claim 12, wherein the forward wall is convex and curvilinear between the first arcuate indentation and the second arcuate indentation.

14. The inner liner of claim 11, wherein the first gate is curved to match the first cut-out and first indentation, and the second gate is curved to match the second cut-out and second indentation.

15. The inner liner of claim 9, wherein the each gate includes a top side, a bottom side, first side, and a second side, both the first side and second side extending between the top side and the bottom side, wherein the first side has the hinged attachment to the at respective side wall and the second side has a spring clip for securing the gate to the receptive side wall.

16. A method for securing a trash bag to an inner liner of a trash receptacle system, the method comprising:
placing the trash bag into the inner liner of the trash receptacle system;
opening a first gate about a first hinged attachment to a first wall of the inner liner of the trash receptacle system thereby exposing a first cut-out located in the first wall;
positioning a first portion of the trash bag across the first cut-out; and
closing the first gate about the first hinged attachment thereby trapping the first portion of the trash bag between the first cut-out and the first gate and securing the trash bag within the inner liner.

17. The method of claim 16 further comprising:
opening a second gate about a second hinged attachment to a second wall of the inner liner of the trash receptacle system thereby exposing a second cut-out located in the second wall, wherein the second cut-out is located opposite the first cut-out;
placing a second portion of the trash bag across the second cut-out, wherein the second portion of the trash bag is opposite the first portion of the trash bag; and
closing the second gate about the second hinged attachment thereby trapping the second portion of the trash bag between the second cut-out and the second gate such that the trash bag is held open and secured within the inner liner.

18. The method of claim 16, further comprising:
placing the inner liner into an outer shell of the trash receptacle system.
